(19) United States
(12) Patent Application Publication
(10) Pub. No.: US 2006/0289235 A1
(43) Pub. Date: Dec. 28, 2006

(54) Rescue system

(76) Inventor: Lin-Hsiung Chen, Yingge Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/166,108

(22) Filed: Jun. 27, 2005

(51) Int. Cl. A62B 1/20

(52) U.S. Cl. 182/192

(57) ABSTRACT

A rescue system is disclosed. The rescue system includes a first base, a second base, a handle member and a rope. The first base is fixed with a fixed pulley and a braking piece while the fixed pulley presses against the braking piece tightly. One side of the second base is pivoted to the first base and the other side thereof is hooked with a locking mechanism on the first base. The handle member is connected to the second base. One end of the handle member, corresponding to the fixed pulley of the first base, is arranged with a removable pulley so as to form a staggered braking mechanism between the fixed pulley and the removable pulley. One end of the rope is fixed on a building and is located between the fixed pulley and the removable pulley. Thus the device has features of easy operation, high safety, high economic effect, and broad applications.

### BACKGROUND OF THE INVENTION

The present invention relates to a rescue system, especially to a rescue system that is easy operated, and is with high efficiency for evacuation from heights.

Nowadays, there are a lot of skyscrapers thus disaster prevention is more getting important. In emergency situation of high-rise buildings, the most common is fire that caused by human. The fire is difficult to prevent or get alarmed in advance. It not only leads damage to our lives and assets but also increases social cost. In order to provide security to high-rise residents in a fire, there is a need to have rescue devices for their escape from danger zones.

There are various kinds of descent and rescue devices for evacuation from heights available on the market. However, rare of them is precisely safe and effective. Some of them have problems of high cost, sophisticated structure that may easily break down, or difficulties in operation. In order to solve above disadvantages of rescue devices, there is a need to provide a rescue device with higher safety, more convenience and higher economic effect.

### SUMMARY OF THE INVENTION

It is a primary object of the present invention to provide a rescue system that is easy to operate and is with best safety so that users can operate smoothly and escape quickly in the event of an emergency for saving their lives.

It is another object of the present invention to provide a rescue system that is compact and easy to set up and store so as to be approached quickly for applications. Thus the efficiency of emergency escape is increased.

It is a further object of the present invention to provide a rescue system with specific compact design as well as live-saving functions. The manufacturing cost is also economic thus the device has many different applications and are used broadly. It can also improve social security.

In order to achieve above objects, the present invention provides a rescue system having a first base, a second base, a handle member and a rope. The first base is fixed with a fixed pulley as well as a braking piece while the fixed pulley presses against the braking piece tightly. The second base has one side pivoted to the first base and the other side thereof is hooked with a locking mechanism on the first base. A slot is disposed on the second base. A handle member is mounted into the slot and pivoted on the second base. One end of the handle member, corresponding to the fixed pulley of the first base, is arranged with a removable pulley so as to form a braking mechanism between the fixed pulley and the removable pulley. One end of the rope is fixed on a building and is positioned between the fixed pulley and the removable pulley. Thus the device can evacuate users to safety.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an embodiment in accordance with the present invention;

FIG. 2 is a top sectional view of an embodiment in accordance with the present invention;

FIG. 3 is a lateral sectional view of an embodiment in accordance with the present invention;

FIG. 4 is a top sectional view of the present invention before assembling;

FIG. 5 is a top sectional view of the present invention after assembling;

FIG. 6 is a schematic drawing showing action of the present invention;

FIG. 7 is a schematic drawing showing operation of the present invention;

FIG. 8 is a perspective view of another embodiment according to the present invention.

### DETAILED DESCRIPTION OF THE PREFFERED EMBODIMENT

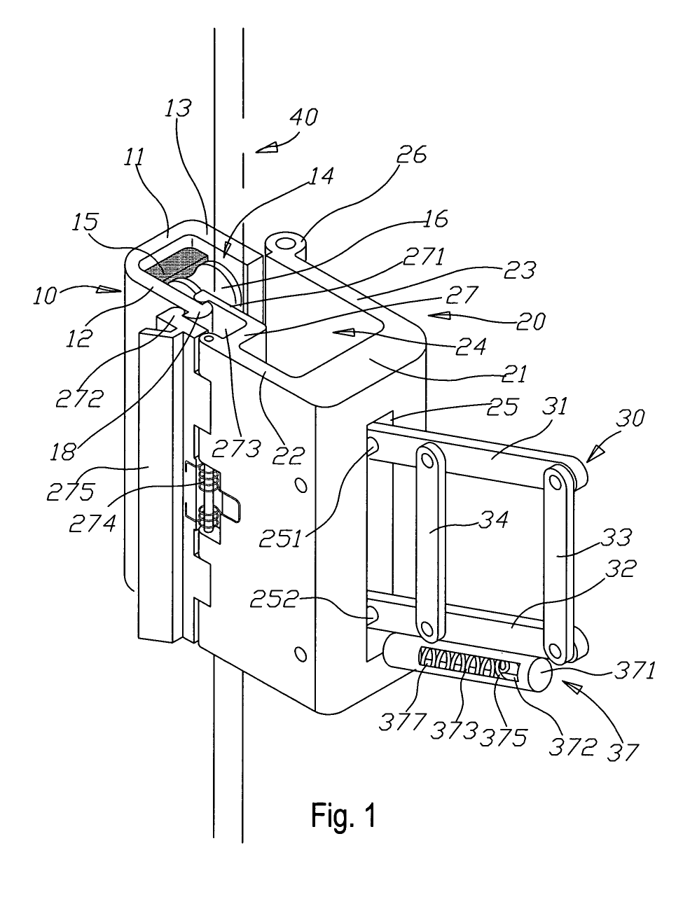

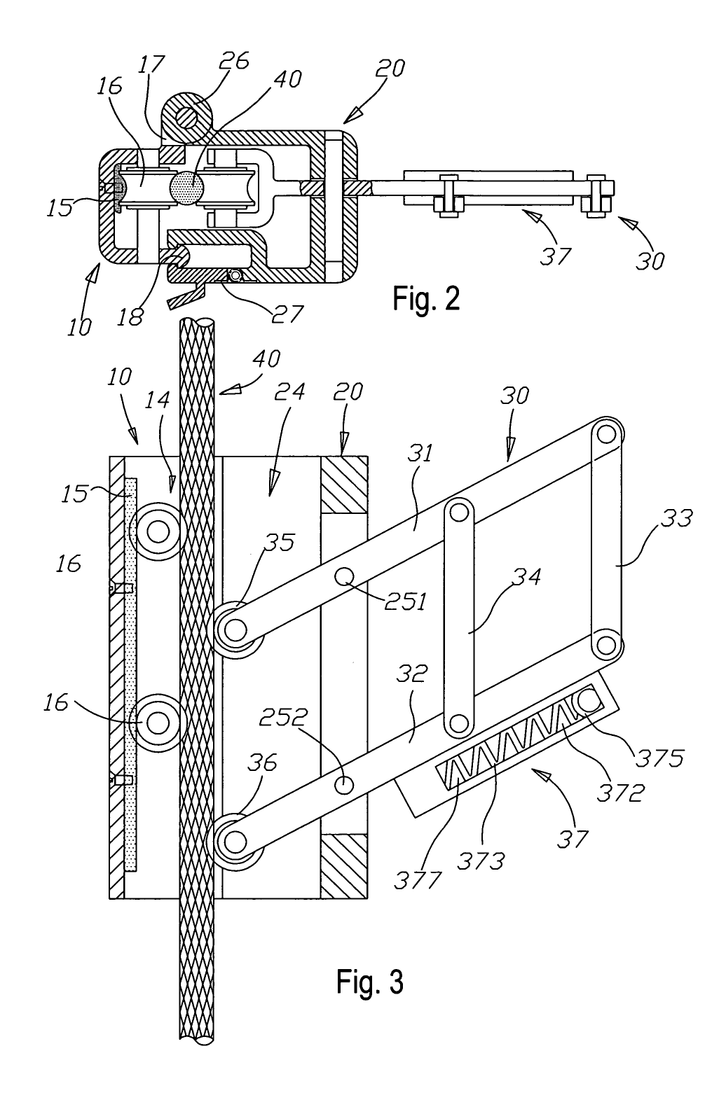

Refer to FIG. 1, FIG. 2 & FIG. 3, a rescue system in accordance with the present invention consists of a first base 10, a second base 20 and a handle member 30. The cross-section of the first base 10 is C-shaped with an opening. The first base 10 is composed by an inner wall 11, two side walls 12, 13, and an accommodation space 14 formed between the walls. A braking piece 15 is threaded on the inner wall 11 while a plurality of fixed pulley 16 is arranged between the two side walls 12, 13 so that the braking piece 15 and the fixed pulley 16 are mounted inside the accommodation space 14. Moreover, the fixed pulley 16 presses against the braking piece 15 firmly. On one side of the opening of the first base 10 is installed with an ear 17 while a male buckle 18 is disposed on the other side, a corresponding to the ear 17.

The cross section of the second base 20 is C-shaped with an opening and the second base 20 having an inner wall 21, two side walls 22, 23, and an accommodation space 24 formed therebetween. A vertical slot 25 is mounted on the inner wall 21. Furthermore, an ear sleeve 26 is disposed on the second base 20, corresponding to the ear 17 of the first base 10. The ear 17 and the ear sleeve 26 are connected pivotally to each other by a shaft so that the first base 10 and the second base 20 are pivoted with each other on one side thereof. A female buckle 27 is arranged on the second base 20, corresponding to the male buckle 18 of the first base 10. The female buckle 27 is composed by a first arm 271, a second arm 272, and a locking groove 273 formed by the first arm 271 and the second arm 272. The second arm 272 is moveable and pivoted on the second base 20 while a torsion spring 274 is disposed on the pivoted position between the second arm 272 and the second base 20 so as to make the second arm 272 locate and lean against the first arm 271 to form a lock. Moreover, a switching member 275 is installed on the second arm 272 for moving the second arm 272.

The handle member 30 is a linkage mechanism and is composed by an upper bar 31, a lower bar 32, an outer vertical bar 33 and an inner vertical bar 34. The upper bar 31 as well as the lower bar 32 is mounted on the slot 25 of the second base 20 and positioned inside the accommodation space 24. By positioning pins 251, 252, the upper bar 31 and the lower bar 32 correspond to each other and both are pivoted on the inner wall 21. One end of the upper bar 31 and the lower bar 32 located inside the accommodation space 24 is pivoted with a removable pulley 35, 36 respectively. The removable pulleys 35, 36 and the fixed pulley 16 are in mutually staggered alignment. The outer vertical bar 33 and the inner vertical bar 34 are pivoted to the outer side and inner side of the upper bar 31 and the lower bar 32 respectively. All the bars form a four-bar linkage.

Moreover, a suspending mechanism 37, including a connecting board 371 and a plurality of connecting hole 372 on the connecting board 371, is arranged on the bottom of the handle member 30. In addition, like general ropes of rescue devices, one end of a rope 40 is fixed on balcony of each floor on buildings and is used in combination with the present invention for safe evacuation.

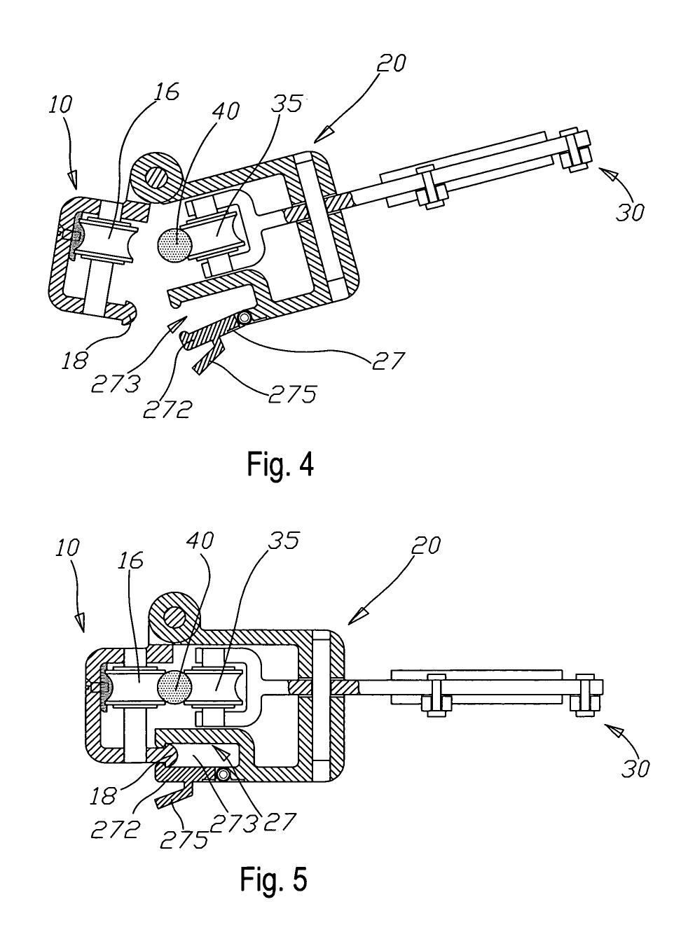

Refer to FIG. 4, once a rescue system according to the present invention is needed in an emergency, it should be assembled with the rope 40 fixed on the building. The rope 40 is installed between the fixed pulley 16 and the removable pulleys 35, 36. Then the male buckle 18 of the first base 10 is inserted into the locking groove 273 of the female buckle 27 on the second base 20 so as to make the first base 10 and the second base 20 engage with each other. The fixed pulley 16 as well as the removable pulleys 35, 36 presses against the rope 40 firmly, as shown in FIG. 5. On the other hand, when users want to remove the rope 40, push the second arm 272 so as to make the male buckle 18 release from the locking groove 273 of the female buckle 27. Thus the first base 10 is unlocked with the second base 20. Therefore, the rope 40 is removed from the locking position between the male buckle 18 and the female buckle 27, as shown in FIG. 4.

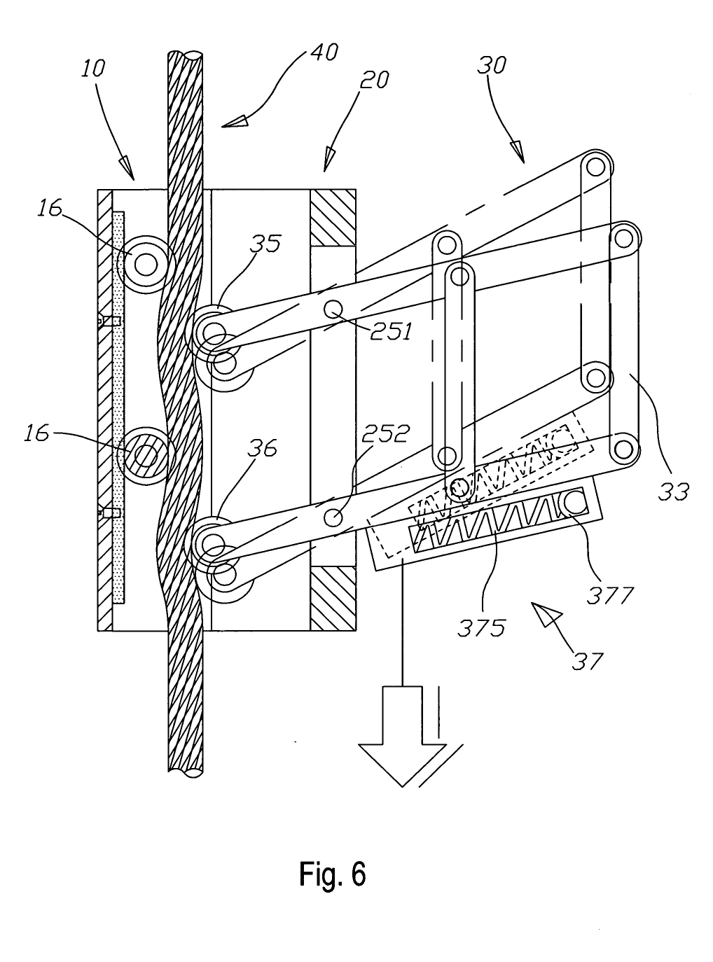

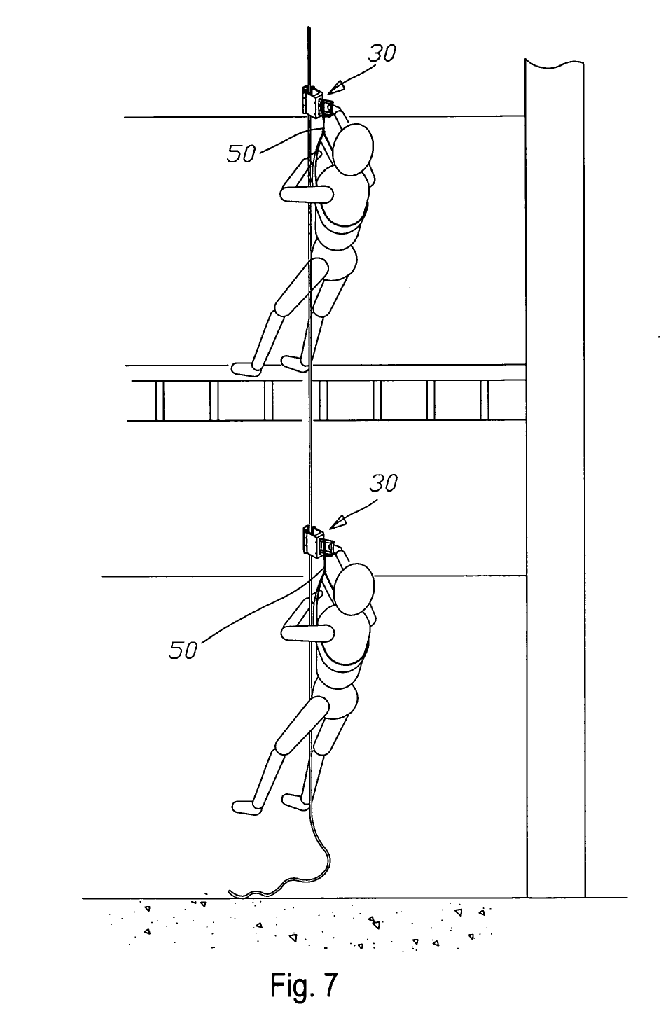

Refer to FIG. 6 & FIG. 7, while lowering users to the ground, one hand of the user holds the rope 40 and the other hand holds the handle member 30. Moreover, a safety accessory device such as a safety belt is hooked onto the connecting hole 372 of the connecting board 371. The handle member 30 uses the leverage principle-positioning pins 251, 252 are used as fulcrum points so that users can choose to hook on the proper connecting hole 372 for controlling the lowering speed. A user with lighter weight is hooked on the connecting hole 372 that is more close to the outer vertical bar 33 while the user with heavy weight is hooked onto the connecting hole 372 far from the outer vertical bar 33. Due to human weight, the handle member 30 moves so as to make the removable pulleys 35, 36 press against the rope 40 toward the fixed pulley 16 more tightly. On the other hand, the fixed pulley 16 has received the resistance from the braking piece 15 so that the lowering speed is steady when gravity acts on the handle member 30 for evacuating people safely from heights. Moreover, the present invention can be used on the same rope 40 for descent of more than one person at a time while general rescue systems make only one person descend on a rope 40 at one time. Thus evacuation speed is increased so as to reduce casualties.

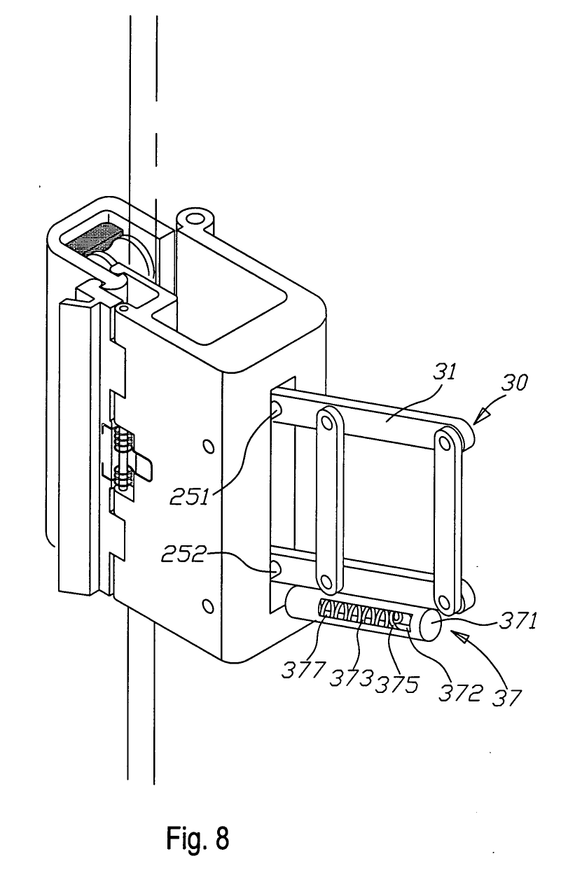

Refer to FIG. 8, another embodiment of the present invention is disclosed. As shown in figure, the difference between this embodiment and above one is in the suspending mechanism 37. The suspending mechanism 37 according to this embodiment consists of an accommodation member 373 with an accommodation space 374 for mounting an elastic element 375 that is a clip or a spring. One end of the elastic element 375 corresponding to the outer vertical bar 33 is disposed with a ring 376 for hooking with the safety belt 50. A slot 377 is arranged on both sides of the accommodation member 373. When being used, the safety belt 50 of the present invention hooks on the ring 376 of the suspending mechanism 37 and the position of the ring 376 is automatically adjusted by the elastic element 375 that is affected by user's weigh. By leverage principle, the positioning pins 251, 252 are used as fulcrum points so as to control lowering speed of users. The compressed length of the elastic element 375 by the user with light weight is less than that by the user with heavy weight.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A rescue system comprising:
a first base fixed with a fixed pulley and a braking piece while the fixed pulley presses against the barking piece firmly;
a second base with one end thereof pivoted with the first base while a locking mechanism is disposed between the other end of the second base and the first base; a slot is arranged on the second base;
a handle member that is a linkage mechanism, having an upper bar, a lower bar, at least a vertical bar connecting the upper bar and the lower bar while the upper bar as well as the lower bar is mounted and pivoted on the slot of the second base; one end of the upper bar and the lower bar, corresponding to the fixed pulley of the first base, is disposed with a removable pulley; and
a rope with one end fixed on a building and positioned between the removable pulley and the fixed pulley.

2. The device as claimed in claim 1, wherein an opening of the first base corresponds to an opening of the second base.

3. The device as claimed in claim 1, wherein the first base having an inner wall and two side walls; the inner wall and the side walls form an accommodation space.

4. The device as claimed in claim 1, wherein the locking mechanism having a male buckle arranged on the first base and a female buckle on the second base.

5. The device as claimed in claim 4, wherein the female buckle further having a first arm, a second arm, and a locking groove formed by the first arm and the second arm; the second arm is moveable and pivoted on the second base.

6. The device as claimed in claim 5, wherein a torsion spring is disposed on the position that the second arm is pivoted to the second base.

7. The device as claimed in claim 5, wherein a switching member is installed on the second arm.

8. The device as claimed in claim 1, wherein the vertical bar having an outer vertical bar and an inner vertical bar.

9. The device as claimed in claim 1, wherein the removable pulley and the fixed pulley are in mutually staggered alignment.

10. The device as claimed in claim 1, wherein a suspending mechanism is set on the bottom of the handle member.

11. The device as claimed in claim 10, wherein the suspending mechanism having a connecting board with a plurality of connecting hole.

12. The device as claimed in claim 10, wherein the suspending mechanism having an accommodation member with an elastic element and at least one slot.

13. The device as claimed in claim 12, wherein a ring is disposed on the elastic element.

14. The device as claimed in claim 12, wherein the elastic element is a spring.

15. The device as claimed in claim 12, wherein the elastic element is a clip.
